(19) United States
(12) Patent Application Publication
(10) Pub. No.: US 2026/0280915 A1
(43) Pub. Date: Sep. 17, 2026

(54) LEAKAGE PREVENTION IN MULTI-VENDOR SMF SOLUTION DEPLOYMENT

(71) Applicant: T-MOBILE INNOVATIONS LLC, Overland Park, KS (US)

(72) Inventors: Kameswaran ARUNACHALAM, Snohomish, WA (US); Ashwani KUMAR, Overland Park, KS (US); Rushabhkumar PATEL, Newcastle, WA (US)

(21) Appl. No.: 19/078,942

(22) Filed: Mar. 13, 2025

(51) Int. Cl. H04L 12/14; H04L 41/0894; H04M 15/00; H04M 15/04

(52) U.S. Cl. CPC H04L 12/1407; H04L 41/0894; H04M 15/04; H04M 15/66

(57) ABSTRACT

Systems and methods are provided for mitigating revenue leakage in a multi-vendor session management function (SMF) solution deployment. In N40-based converged charging implementation, a quota management indicator (QMI) is used to distinguish between online and offline packet data unit (PDU) sessions. Online sessions include QMI, while offline sessions do not. In a multi-vendor SMF solution, any one of the SMF solutions may not comply with 3GPP standards regarding utilizing QMI (i.e., QMI is included by default regardless of session type). This can lead to revenue leakage in offline billing since the offline sessions are not correctly identified. The present disclosure provides a mediation server that processes call data records (CDRs) based on a source identifier rather than QMI. Specifically, the mediation server can ignore logic instructing discarding CDRs having QMI (as it does normally) and, instead, process the CDRs having QMI. This reduces the risk of revenue leakage.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for mitigating revenue leakage. More particularly, in aspects set forth herein, systems and methods enable mitigating revenue leakage in a multi-vendor session management function (SMF) solution deployment. In N40-based converged charging implementation, a quota management indicator (QMI) is used to distinguish between online and offline packet data unit (PDU) sessions. Online sessions include QMI, while offline sessions do not. In a multi-vendor SMF solution, any one of the SMF solutions may not comply with 3GPP standards regarding utilizing QMI (i.e., QMI is included by default regardless of session type). This can lead to revenue leakage in offline billing since the offline sessions are not correctly identified.

The present disclosure provides a mediation server that processes call data records (CDRs) based on a source identifier rather than QMI. Specifically, the mediation server typically implements logic instructing discarding CDRs having QMI and only processing those without QMI to eliminate duplicate billing. Instead, the mediation server can ignore the instruction to discard the CDRs having QMI and process the CDRs having QMI. This reduces the risk of revenue leakage.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a flow diagram of a method for mitigating revenue leakage, in accordance with aspects herein;

FIG. 3 depicts a flow diagram of a method for mitigating revenue leakage, in accordance with aspects herein; and

FIG. 4 depicts a diagram of an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
AMF Access & Mobility Management Function
APN Access Point Name
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCF Policy Control Function
PCS Personal Communications Service
PDA Personal Digital Assistant
RAM Random Access Memory
RET Remote Electrical Tilt
RF Radio-Frequency
RFI Radio-Frequency Interference
R/N Relay Node
ROM Read Only Memory
SINR Transmission-to-Interference-Plus-Noise Ratio
SMF Session Management Function
SNR Transmission-to-noise ratio
SON Self-Organizing Networks
TDMA Time Division Multiple Access
TXRU Transceiver (or Transceiver Unit)
UDM Unified Data Management Function
UDR Unified Data Repository
UE User Equipment
UPF User Plane Function

Further, various technical terms are used throughout this description. An illustrative resource that fleshes out various aspects of these terms can be found in Newton's Telecom Dictionary, 32d Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller.

As employed herein, a UE (also referenced herein as a user device) or WCD can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

In conventional cellular communications technology, a 5G telecommunications network comprises a 5G Core Network (5GC) and a gNB. The 5GC architecture, as known to those in the art, relies on a Service-Based Architecture (SBA) framework where the architecture elements are defined in terms of Network Functions (NF) rather than by traditional network entities. Using interfaces of a common framework, any NF can offer its services to other NFs that are permitted to make use of their functions. In aspects, multi-vendor solutions can be implemented for various NF. Specifically, as it pertains herein, multi-vendor session management function (SMF) solutions can be implemented. Risks can be associated with multi-vendor solutions such as setup costs, potential for down time, diagnostic challenges, failure to comply with standards, and the like. However, multiple benefits are also found in multi-vendor solutions such as an ability to provide a service faster, choosing the best partnerships and product offerings, etc.

The present disclosure is directed to mitigating revenue leakage in a multi-vendor SMF solution deployment. Through deployment of various solutions, it became apparent that some vendors do not comply with 3GPP standards regarding QMI utilization. 3GPP requires that QMI is included for sessions that are online data sessions but that QMI need not be included for sessions that are offline data sessions. This allows networks to easily distinguish offline from online data sessions for appropriate billing. Thus, in a typical QMI-based processing solution, a mediation server may include logic that dictates the mediation server discard call data records (CDRs) having QMI and process CDRs without QMI. When a solution fails to appropriately identify CDRs (i.e., QMI is included by default rather than by session type), this logic results in discarding all of the CDRs from the faulty solution such that no billing is generated; hence, revenue leakage.

Accordingly, a first aspect of the present disclosure is directed to a system for mitigating data leakage. The system comprises a node having one or more antennas, the node being associated with a wireless telecommunications network; one or more processors communicatively coupled with the node; and computing memory storing computer-usable instructions that, when executed by the one or more processors, perform operations comprising: receiving one or more call detail records (CDRs), wherein each of the one or more CDRs comprise usage data, wherein the usage data comprises a quota management indicator (QMI) for a first CDR; identifying a data network identifier associated with the first CDR, wherein the data network identifier is associated with a source that only provides CDRs having QMIs; bypassing an instruction to discard any CDRs having QMIs and processing the CDRs having QMIs; and generating billing data for the CDRs having QMIs.

A second aspect of the present disclosure is directed to a method for mitigating data leakage. The method comprises receiving one or more call detail records (CDRs), wherein each of the one or more CDRs comprise usage data, wherein the usage data comprises a quota management indicator (QMI) for a first CDR; identifying a data network identifier associated with the first CDR, wherein the data network identifier is associated with a source that only provides CDRs having QMIs; bypassing an instruction to discard any CDRs having QMIs and processing the CDRs having QMIs; and generating billing data for the CDRs having QMIs.

Another aspect of the present disclosure is directed to one or more non-transitory computer storage media having computer-executable instructions embodied thereon, that when executed by at least a processor, cause the at least one processor to perform a method for mitigating data leakage. The method comprises receiving one or more call detail records (CDRs), wherein each of the one or more CDRs comprises usage data; identifying a first data network identifier associated with a first CDR, wherein the first data network identifier is associated with a first source that provides both CDRs having quota management indicators (QMIs) and CDRs without QMIs; identifying a second data network identifier associated with a second CDR, wherein the second data network identifier is associated with a second source that provides only CDRs having QMIs; for the first data network identifier, executing an instruction to discard any CDRs having QMIs and processing only CDRs without QMIs; and for the second data network identifier, bypassing the instruction to execute any CDRs having QMIs and processing the CDRs having QMIs.

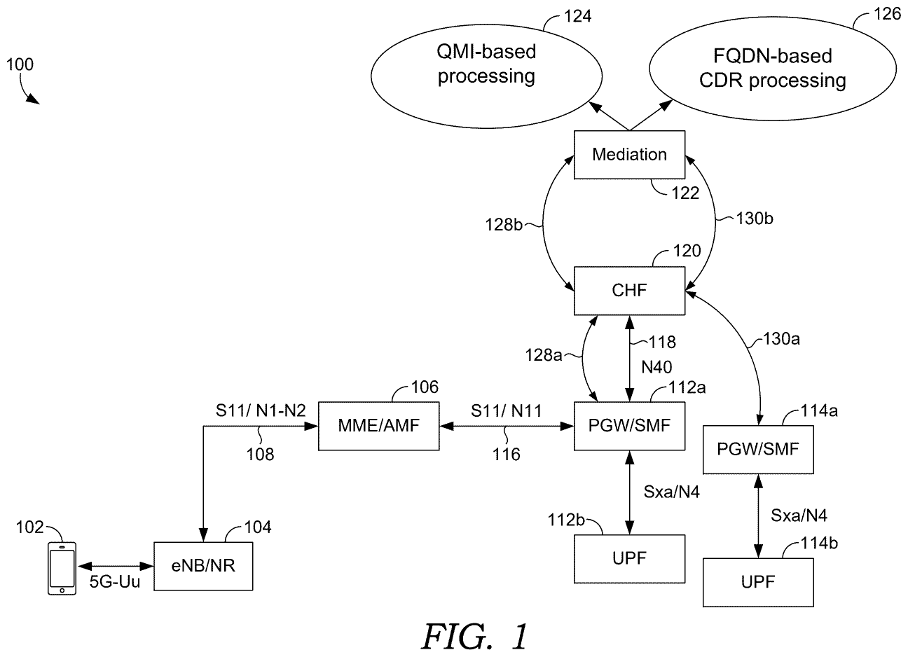

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

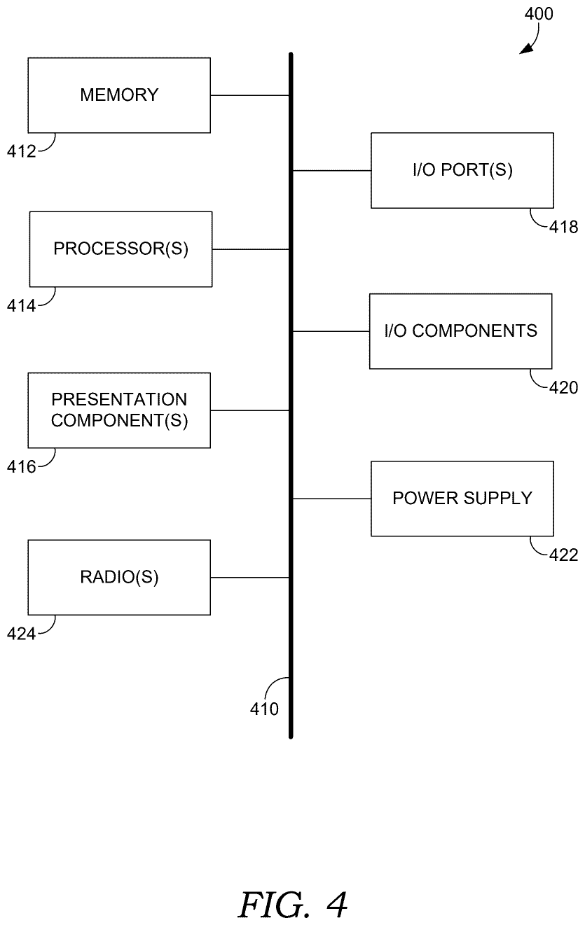

A network cell may comprise a base station to facilitate wireless communication between a communications device within the network cell, such as communications device 400 described with respect to FIG. 4, and a network. As shown in FIG. 1, communications device may be UE 102. In the network environment 100, UE 102 may communicate with other devices, such as mobile devices, servers, etc. The UE 102 may take on a variety of forms, such as a personal computer, a laptop computer, a tablet, a netbook, a mobile phone, a Smart phone, a personal digital assistant, or any other device capable of communicating with other devices. For example, the UE 102 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 102 comprises a wireless or mobile device with which a wireless telecommunication network(s) can be utilized for communication (e.g., voice and/or data communication). In this regard, the UE 102 can be any mobile computing device that communicates by way of, for example, a 5G network.

The UE 102 may utilize a network to communicate with other computing devices (e.g. mobile device(s), a server(s), a personal computer(s), etc.). In embodiments, the network is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, the network is associated with a telecommunications provider that provides services to user devices, such as UE 102. For example, the network may provide voice services to user devices or corresponding users that are registered or subscribed to utilize the services provided by a telecommunications provider.

As previously mentioned, CDRs are generated for use in, for instance, billing in a telecommunications network. CDRs can include a date and time of a communication (e.g., data/time stamp), a source phone number and a destination phone number, a type of communication (e.g., data session, voice call, etc.), and the like. Additionally, in N40-based converged charging, quota management indicators (QMIs) is used to manage charging and quota allocations for PDU sessions. The QMI is included in the CDR.

As previous noted, online sessions (e.g., pre-paid calling cards) include QMI while offline sessions (e.g., monthly subscription) do not include QMI. In present systems, usage metering is based on QMI values received from an SMF. Current implementations result in a charging function (CHF) generating CDRs with QMI (for online charging) and without QMI (for offline charging) in two different containers. Once the CDRs are communicated from the CHF to the mediation server, containers with QMI are dropped/discarded and containers without QMI are processed for offline-based charging to avoid duplicate billing.

When a SMF solution fails to properly create the two containers (i.e., a container with QMI for online charging and a container without QMI for offline charging), the mediation server is at risk of not properly metering usage. For instance, the logic at the mediation server instructs it to discard containers with QMI. However, deployment of several SMF solutions has identified that said SMF solutions are improperly generating usage data and sending a single container with QMI. In other words, QMI values are being included by default rather than by session type (i.e., no distinguishing between online and offline session types in some SMF solutions). Thus, if the mediation server discards containers with QMI but a first SMF solution is only communicating containers with QMI, all of the usage data communicated from the first SMF solution is being discarded without adequate usage metering/billing.

The present solution offers an architecture to address this issue. In particular, both QMI-based processing (i.e., processing according to QMI values being present or not) and a source identifier-based processing can be implemented in parallel in a network. FIG. 1 illustrates such an environment 100. As shown, a user equipment (UE) 102 is illustrated as establishing a session with a network shown as an eNB (e.g., 4G)/new radio (NR) (e.g., 5G) 104. The UE 102 successfully attaches/registers to the LTE/5G network via the interface 108 with the mobility management entity (MME) or access and mobility function (AMF) 106, depending on whether it is an LTE or 5G architecture, both of which can utilize the present solution. Upon successful registration, the UE 102 initiates a PDU session establishment procedure towards a packet gateway (PGW) session management function (SMF) 112a or 114a. The PGW/SMF 112a or 114a establishes a session with a user plane function (UPF) 112b or 114b (depending on the vendor used). Once successful, the UPF 112b or 114b starts reporting data usage information to the SMF 112a or 112b. In a typical example, the SMF 112a sends the usage reporting information to the charging function (CHF) 120 via the N40 interface 118. The CHF 120 further generates CDRs for the mediation server 122, which starts metering the usage based on the online/offline indicator (QMI) dictated by the QMI-based processing logic 124.

As noted earlier, if the QMI is improperly included, the QMI-based processing logic 124 will dictate that CDRs having a QMI be discarded, which could result in elimination of all usage from a source. Thus, prior to any processing, the mediation server 122 can identify a source identifier that identifies a source of the usage data. The source can be an SMF external vendor solution. The source identifier can be a network function fully qualified domain name (NF-FQDN). If the mediation server 122 identifies the CDR as associated with a source identifier NF-FQDN that complies with 3GPP standard related to QMI utilization, the CDRs having the approved NF-FQDN can be processed according to the QMI-based processing logic 124 by the mediation server 122. In other words, the CDRs having QMI can be discarded and only the CDRs without QMI are processed.

However, if the CDR is associated with a NF-FQDN of a source that does not properly utilize 3GPP standards for QMI utilization (i.e., fails to comply with 3GPP standards) then NF-FQDN-based processing logic 126 can be implemented. NF-FQDN-based processing overrides the instruction to discard CDRs having QMI values and only process CDRs without QMI. Rather, NF-FQDN-based processing allows the mediation server 122 to process the CDRs with QMI values to mitigate potential revenue leakage. Thus, CDRs received from PGW/SMF 112a can be routed through typical QMI-based processing logic 124 at the mediation server 122 via interfaces 128a and 128b. CDRs received from PGW/SMF 114a can be subject to NF-FQDN-based processing 126 via interfaces 130a and 130b. In this example, PGW/SMF 112a is found to properly apply QMI values and PGW/SMF 114a is not applying QMI values according to 3GPP standards. Thus, the PGW/SMF 112 a communicates usage data via the N40 interface 118 at communication 128a and CDRs are generated with and without QMI at communication 128b. Conversely, the PGW/SMF 114a communicates usage data via the N40 interface 118 at communication 130a and CDRs are generated with QMI only at communication 130b.

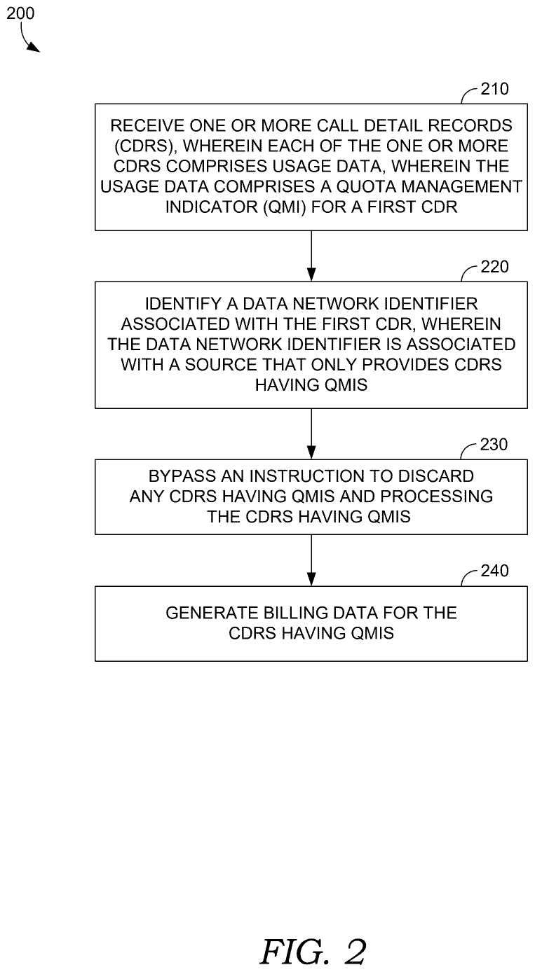

Turning to FIG. 2, a flow diagram 200 is provided illustrating a flow to mitigate revenue leakage. Initially, at block 210, one or more call detail records (CDRs) is received. Each of the one or more CDRs comprises usage data including a quota management indicator (QMI) for a first CDR. At block 220, a data network identifier associated with the first CDR is identified, wherein the data network identifier is associated with a source that only provides CDRs having QMIs. The data network identifier is, in aspects, a NF-FQDN. At block 230, an instruction to discard any CDRs having QMIs is bypassed and the CDRs having QMIs are processed. At block 240, billing data is generated for the CDRs having QMIs.

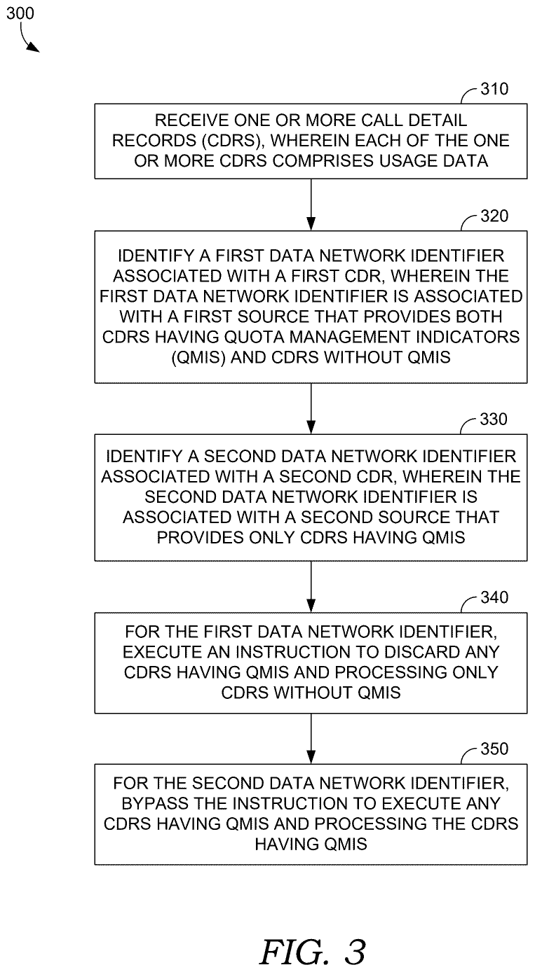

Referring to FIG. 3, a flow diagram 300 is provided illustrating a flow to mitigate revenue leakage. At block 310, receiving one or more call detail records (CDRs) is received, wherein each of the one or more CDRs comprises usage data. At block 320, a first data network identifier associated with a first CDR is identified. The first data network identifier is associated with a first source that provides both CDRs having quota management indicators (QMIs) and CDRs without QMIs. At block 330, a second data network identifier associated with a second CDR is identified, wherein the second data network identifier is associated with a second source that provides only CDRs having QMIs. At block 340, for the first data network identifier, an instruction to discard any CDRs having QMIs is executed and only CDRs without QMIs are processed. At block 350, for the second data network identifier, the instruction to execute any CDRs having QMIs is bypassed and the CDRs having QMIs are processed.

Referring to FIG. 4, a block diagram of an exemplary computing device 400 suitable for use in implementations of the technology described herein is provided. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. It should be noted that although some components in FIG. 4 are shown in the singular, they may be plural. For example, the computing device 400 might include multiple processors or multiple radios. In aspects, the computing device 400 may be a UE/WCD, or other user device, capable of two-way wireless communications with an access point. Some non-limiting examples of the computing device 400 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 4, computing device 400 includes a bus 410 that directly or indirectly couples various components together, including memory 412, processor(s) 414, presentation component(s) 416 (if applicable), radio(s) 424, input/output (I/O) port(s) 418, input/output (I/O) component(s) 420, and power supply(s) 422. Although the components of FIG. 4 are shown with lines for the sake of clarity, in reality, delineating various components is not so clear, and metaphorically, the lines would more accurately be grey and fuzzy. For example, one may consider a presentation component such as a display device to be one of I/O components 420. Also, processors, such as one or more processors 414, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 412 may take the form of memory components described herein. Thus, further elaboration will not be provided here, but it should be noted that memory 412 may include any type of tangible medium that is capable of storing information, such as a database. A database may be any collection of records, data, and/or information. In one embodiment, memory 412 may include a set of embodied computer-executable instructions that, when executed, facilitate various functions or elements disclosed herein. These embodied instructions will variously be referred to as “instructions” or an “application” for short.

Processor 414 may actually be multiple processors that receive instructions and process them accordingly. Presentation component 416 may include a display, a speaker, and/or other components that may present information (e.g., a display, a screen, a lamp (LED), a graphical user interface (GUI), and/or even lighted keyboards) through visual, auditory, and/or other tactile cues.

Radio 424 represents a radio that facilitates communication with a wireless telecommunications network. Illustrative wireless telecommunications technologies include CDMA, GPRS, TDMA, GSM, and the like. Radio 424 might additionally or alternatively facilitate other types of wireless communications including Wi-Fi, WiMAX, LTE, 3G, 4G, LTE, mMIMO/5G, NR, VoLTE, or other VoIP communications. As can be appreciated, in various embodiments, radio 424 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 418 may take a variety of forms. Exemplary I/O ports may include a USB jack, a stereo jack, an infrared port, a firewire port, other proprietary communications ports, and the like. Input/output (I/O) components 420 may comprise keyboards, microphones, speakers, touchscreens, and/or any other item usable to directly or indirectly input data into the computing device 400.

Power supply 422 may include batteries, fuel cells, and/or any other component that may act as a power source to supply power to the computing device 400 or to other network components, including through one or more electrical connections or couplings. Power supply 422 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which for a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for mitigating data leakage, the system comprising:
a node having one or more antennas, the node being associated with a wireless telecommunications network;
one or more processors communicatively coupled with the node; and
computing memory storing computer-usable instructions that, when executed by the one or more processors, perform operations comprising:
receiving one or more call detail records (CDRs), wherein each of the one or more CDRs comprise usage data, wherein the usage data comprises a quota management indicator (QMI) for a first CDR;
identifying a data network identifier associated with the first CDR, wherein the data network identifier is associated with a source that only provides CDRs having QMIs;
bypassing an instruction to discard any CDRs having QMIs and processing the CDRs having QMIs; and
generating billing data for the CDRs having QMIs.

2. The system of claim 1, wherein the one or more CDRs are compiled from data received over an N40 interface in a 5G network.

3. The system of claim 1, wherein the one or more CDRs are received from a charging function (CHF) in a 5G network.

4. The system of claim 1, wherein the usage data comprises a date, time, duration, source and destination phone numbers, and a type of communication.

5. The system of claim 4, wherein the type of communication is a data communication.

6. The system of claim 5, wherein the QMI indicates whether the data communication is an offline or online usage.

7. The system of claim 1, wherein the instruction to discard any CDRs having QMIs is executed when received from a source that provides both CDRs having QMIs and CDRs without QMIs.

8. A method for mitigating data leakage, the method comprising:
receiving one or more call detail records (CDRs), wherein each of the one or more CDRs comprise usage data, wherein the usage data comprises a quota management indicator (QMI) for a first CDR;
identifying a data network identifier associated with the first CDR, wherein the data network identifier is associated with a source that only provides CDRs having QMIs;
bypassing an instruction to discard any CDRs having QMIs and processing the CDRs having QMIs; and
generating billing data for the CDRs having QMIs.

9. The method of claim 8, wherein the one or more CDRs are compiled from data received over an N40 interface in a 5G network.

10. The method of claim 8, wherein the one or more CDRs are received from a charging function (CHF) in a 5G network.

11. The method of claim 8, wherein the usage data comprises a date, time, duration, source and destination phone numbers, and a type of communication.

12. The method of claim 11, wherein the type of communication is a data communication.

13. The method of claim 12, wherein the QMI indicates whether the data communication is an offline or online usage.

14. The method of claim 8, wherein the instruction to discard any CDRs having QMIs is executed when received from a source that provides both CDRs having QMIs and CDRs without QMIs.

15. The method of claim 14, wherein a source providing CDRs without QMIs fails to comply with 3GPP standards.

16. One or more non-transitory computer storage media having computer-executable instructions embodied thereon, that when executed by at least one processor, cause the at least one processor to perform a method comprising:
receiving one or more call detail records (CDRs), wherein each of the one or more CDRs comprises usage data;
identifying a first data network identifier associated with a first CDR, wherein the first data network identifier is associated with a first source that provides both CDRs having quota management indicators (QMIs) and CDRs without QMIs;
identifying a second data network identifier associated with a second CDR, wherein the second data network identifier is associated with a second source that provides only CDRs having QMIs;
for the first data network identifier, executing an instruction to discard any CDRs having QMIs and processing only CDRs without QMIs; and
for the second data network identifier, bypassing the instruction to execute any CDRs having QMIs and processing the CDRs having QMIs.

17. The one or more non-transitory computer storage media of claim 16, wherein the QMI indicates whether the usage data is online or offline usage.

18. The one or more non-transitory computer storage media of claim 16, wherein the one or more CDRs are compiled from data received over an N40 interface in a 5G network.

19. The one or more non-transitory computer storage media of claim 16, wherein the one or more CDRs are received from a charging function (CHF) in a 5G network.

20. The one or more non-transitory computer storage media of claim 16, wherein the first and second network identifiers are network function fully qualified domain name (NF-FQDN) identifiers.
